(19) United States
(12) Patent Application Publication
(10) Pub. No.: US 2026/0129280 A1
(43) Pub. Date: May 7, 2026

(54) SYSTEMS AND METHODS FOR CONFIGURING AN IMAGING TOOL USING GENERATIVE AI

(71) Applicant: Zebra Technologies Corporation, Lincolnshire, IL (US)

(72) Inventor: Matthew M. Degen, Ridge, NY (US)

(21) Appl. No.: 18/934,628

(22) Filed: Nov. 1, 2024

(51) Int. Cl. H04N 23/617; G06V 30/14; H04N 17/00

(52) U.S. Cl. CPC H04N 23/617; G06V 30/14; H04N 17/002

(57) ABSTRACT

Systems and methods for controlling an imaging tool associated with performing an imaging task are disclosed. An example method may include a model receiving image data comprising at least one image including text, and control data associated with the imaging tool that indicates a description of the imaging task, a plurality of settings of the imaging tool associated with performing the imaging task, and a schema of tool configuration data that configures the plurality of settings. The method may include the model generating tool configuration data for the imaging tool that indicates one or more values corresponding to at least a portion of the plurality of settings. The method may include configuring the imaging tool using the tool configuration data.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

An application for performing an imaging task on an image, such as a machine vision tool for optical character recognition or barcode decoding, can have many settings which configure the application for performing the imaging task. Some examples of setting may include determining a region of interest of the image to analyze for performing the particular imaging task, the average character height of text to be recognized in an image, the contrast of text or other symbology in the image, the color of the text to be identified, etc. The values of the application settings are not always self-evident or easily determined, causing difficulty for the application user while configuring the setting and/or resulting in settings that may not be appropriate for a given subject image and/or imaging task. The trial and error process to arrive at suitable application settings can be frustrating and time consuming for the user, and also unnecessarily expends computing resources (e.g., processing cycles, memory, power, etc.) while testing various applications settings on subject images. Thus, there exists an opportunity for configuring an imaging tool generative artificial intelligence.

### BRIEF SUMMARY

In one aspect, a method for configuring an imaging tool associated with performing an imaging task may include: receiving, at a model image data comprising at least one image, wherein the at least one image includes text, and control data associated with the imaging tool, wherein the control data indicates: a description of the imaging task, a plurality of settings of the imaging tool associated with performing the imaging task, and a schema of tool configuration data that configures the plurality of settings; generating, via the model, the tool configuration data for the imaging tool, wherein the tool configuration data indicates one or more values corresponding to at least a portion of the plurality of settings; and configuring the imaging tool using the tool configuration data.

In a variation of the aspect, generating the tool configuration data may include eliminating at least one setting of the plurality of settings being configured by the tool configuration data based upon the image data; and/or limiting a range of values of the one or more values corresponding to at least the portion of the plurality of settings based upon the image data.

In another variation of the aspect, the method may include receiving an indication of the imaging tool, of a plurality of imaging tools, wherein receiving at least the control data at the model is responsive to receiving the indication of the imaging tool.

In yet another variation of the aspect, the tool configuration data may include a JSON file.

In still yet another variation of the aspect, the plurality of settings may be associated with performing optical character recognition on an image.

In a variation of the aspect, the plurality of settings may include one or more of: a confidence metric, an average character height, a color of the text, a contrast threshold, a character width, a character range, a region of interest, a string match, or text optimization.

In another variation of the aspect, the method may include a base model configured to generate a plurality of configuration datasets corresponding to a plurality of tools, wherein: the plurality of configuration datasets includes the tool configuration data, the plurality of tools include the imaging tool, fine-tuning of the base model generates the model, the fine-tuning configures the model to generate the tool configuration data for the imaging tool, and the fine-tuning causes the model to have better performance generating the tool configuration data for the imaging tool respective to performance of the base model generating the tool configuration data for the imaging tool.

In yet another variation of the aspect, the model may include one or more of a neural network, a generative model, or a language model.

In still yet another variation of the aspect, the control data may include one or more prompts configured for the model.

In a variation of the aspect, the model may be configured to determine a region of interest (ROI) and/or generate the tool configuration data is based upon the ROI in the at least one image.

In another variation of the aspect, the method may include performing the imaging task on a set of test images comprising test image data using the imaging tool configured with the tool configuration data; determining whether performance of the imaging task achieves one or more metrics associated with the imaging task; responsive to achieving the one or more metrics, generating imager configuration data for configurating operational parameters of an imaging device, aa based upon the tool configuration data, and providing the imager configuration data to the imaging device; and responsive to not achieving the one or more metrics, modifying the tool configuration data via the model to improve the performance of the imaging task on the set of test images using the imaging tool.

In yet another variation of the aspect, the operational parameters may be associated with one or more of: an exposure, a focal distance, a spatial resolution, an aperture, a shutter speed, a sensor gain, an image processing, an illumination, or a decoder.

In another variation of the aspect, the model may iteratively modify the tool configuration data until the one or more metrics are achieved by the imaging tool.

In another aspect, a system for configuring an imaging tool associated with performing an imaging task may include a model stored on one or more memories; one or more processors; and the one or more memories storing processor-executable instructions that, when executed by the one or more processors, cause the system to: receive, at the model image data comprising at least one image, wherein the at least one image includes text, and control data associated with the imaging tool, wherein the control data indicates: a description of the imaging task, a plurality of settings of the imaging tool associated with performing the imaging task, and a schema of tool configuration data that configures the plurality of settings, generate, via the model, the tool configuration data for the imaging tool, wherein the tool configuration data indicates one or more values corresponding to at least a portion of the plurality of settings, and configure the imaging tool using the tool configuration data.

In yet another aspect, a non-transitory computer-readable medium may store instructions that, when executed by one or more processors, cause the one or more processors to: receive, at a model image data comprising at least one image, wherein the at least one image includes text, and control data associated with an imaging tool, wherein the control data indicates a description of an imaging task, a plurality of settings of the imaging tool associated with performing the imaging task, and a schema of tool configuration data that configures the plurality of settings; generate, via the model, the tool configuration data for the imaging tool, wherein the tool configuration data indicates one or more values corresponding to at least a portion of the plurality of settings; and configure the imaging tool using the tool configuration data.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 an example environment in which systems and methods for configuring an imaging tool using generative artificial intelligence (AI) may be implemented, according to embodiments.

FIG. 2 is a block diagram depicting an example processing platform for implementing example methods and/or operations described herein, according to embodiments.

FIG. 3 is a perspective view of an example imaging device, according to embodiments.

FIG. 4 is a flow diagram depicting example training and operation of a machine learning model, according to embodiments.

FIG. 5 depicts an example graphical user interface of an example OCR imaging tool, according to embodiments

FIG. 6 is a flow diagram of an example method for configuring an imaging tool to perform an imaging task, according to embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### Overview

The disclosed techniques provide systems and methods for configuring an imaging tool associated with performing an imaging task using generative artificial intelligence (AI). The methods and systems may include a model, such as a multimodal generative AI model (e.g., OpenAI GPT-4, Google Gemini) which configures settings of an imaging tool performing an OCR imaging task on a subject image, however, the model may be configure setting for other imaging tasks. To configure the imaging tool for performing the OCR imaging task, the model may receive image data comprising at least one image including text, and control data associated with the imaging tool. The control data may indicate a description of the imaging task, a plurality of image tool settings associated with performing the imaging task, and a schema of tool configuration data that configures the plurality of settings.

The model may generate the tool configuration data. For example, the imaging tool may generate a graphical user interface (GUI) with allows the user to select a function associated with generating the tool configuration data. The model may analyze one or more images of the image data along with the control data to generate the tool configuration data indicating one or more values of corresponding image tool settings. For example, the model may analyze the image to identify the text, the size of the text, the position of the text, the text color, the image background color, and/or other relevant information about the image. Based upon the image analysis and information in the control data (e.g., prompts for the model, expected model responses to the prompts, examples of the schema of the tool configuration data for configuring the settings, etc.), the model may generate tool configuration data optimized to successfully recognize text in the image or otherwise successfully perform the OCR imaging task.

The disclosed techniques may include configuring the imaging tool using the tool configuration data, for example so a user can immediately see the results of the imaging tool performing the OCR task on a subject image using the image tool settings indicated by the tool configuration data.

As described above, configuring the imaging tool for an imaging task may include determining a multitude of value for respective imaging tool settings, such that determining which values of which setting allow the imaging tool to successfully perform the imaging task, let alone setting that optimize the imaging tool's performance of the task, may be difficult and confusing for the user. Moreover, the settings from one imaging tool and/or imaging task to another may vary greatly, further complicating image tool configuration. Successively generating sets of tool configuration data and testing various imaging tool settings provided thereby on subject images is not only time consuming for the user, but wastes computing resources of the computing device(s) supporting or otherwise executing the imaging tool, including power (e.g., to run the computing device(s)), processing cycles (e.g., process the subjects images and generate sets of tool configuration data), memory (e.g., to store the subject images and the sets of tool configuration data), etc.

To overcome these technical hurdles, the disclosed systems and methods utilize generative AI to generate tool configuration data (e.g., code) that configures and optimizes the imaging tool to successfully perform the subject imaging task. The disclosed techniques provide a technical improvement over conventional techniques at least by improving the functionality of a computing device (e.g., executing the imaging tool). In particular, the model can automatically generate tool configuration data for performing one or more imaging tasks without user intervention, minimizing if not eliminating the need for trial and error to determine imaging tool settings that result in successful performance of the imaging task. Implementing a generative model to generate the tool configuration data provides the computing device with new, enhanced capabilities. Moreover, using the model to expeditiously determine which combination of settings will best achieve successful performance of the imaging task saves computing resources otherwise expended when determining imaging settings iteratively through trial and error. The disclosed techniques further provide an improvement in the technical field of imaging tool configuration as compared to conventional techniques which require user intervention to select imaging tool settings. Thus, the computing resources and time required to configure the imaging tool to perform the imaging task is a fraction of what is otherwise required using conventional techniques, such benefits and advantages increasing exponentially when scaling the disclosed techniques to configure dozens, hundreds, or even thousands of imaging tools for imaging tasks.

### Example Environment

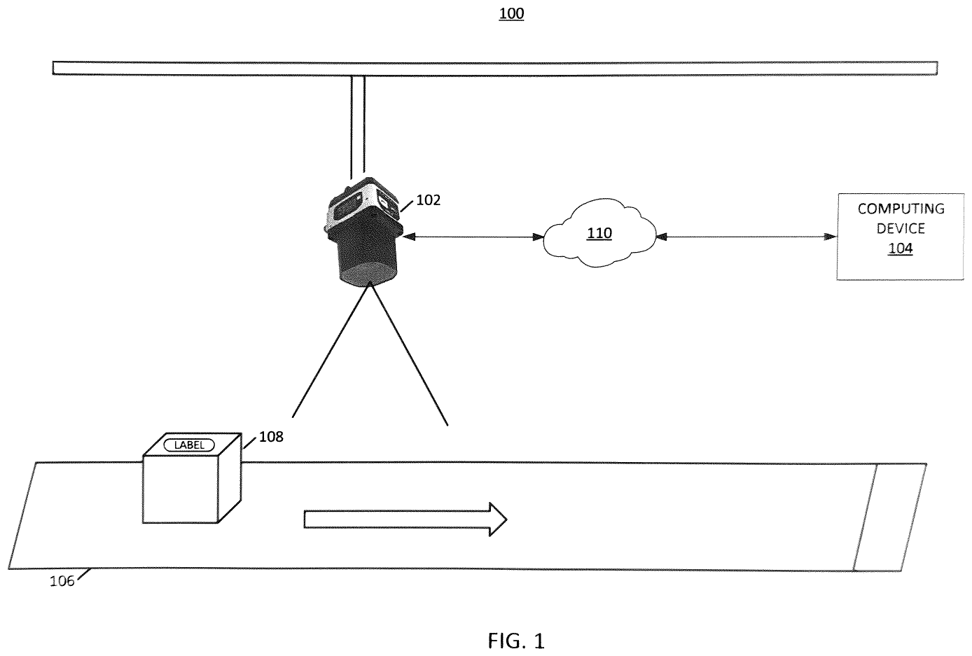

FIG. 1 depicts an example environment 100 in which systems and methods for configuring an imaging tool using generative artificial intelligence (AI) may be implemented, according to embodiments. The example environment 100 may include at least one imaging device 102 communicatively coupled to at least one computing device 104 via a network 110.

The imaging device 102 may be or include one or more of machine vision cameras, 3D imaging devices, 2D imaging devices, and/or any other suitable imaging device. The imaging device 102 may be configured to capture image data comprising one or more images of its field of view, and perform an imaging task on the captured images. For example, the imaging device 102 may be positioned proximate a conveyor belt 106 transporting an object 108, and configured to capture images of the object 108 as it crosses the imaging device's 102 field of view to detect text on the object 108.

In at least some embodiments, to perform an imaging task, one or more operational parameters of the imaging device 102 may be configured via imager configuration data (e.g., one or more JSON files). The operational parameters of the imaging device 102 may include and/or be associated with exposure, focal distance, spatial resolution, the aperture, shutter speed, sensor gain, image processing, illumination, a decoder, and/or other suitable operational parameters of the imaging device 102. For example, the imager configuration data may configure the imaging device 102 to perform optical character recognition (OCR) images of the object 108 to identify text or other symbology on the object (e.g., text associated with a label on the object 108), for example configuring hardware settings of the imaging device 102, settings of software/firmware/modules of the imaging device 102 performing the imaging task, etc.

The imaging tool may execute one or more models, such as machine learning models, to generate tool configuration data (e.g., one or more JSON files) that configures one or more setting of the imaging tool for performing the imaging task. The model (e.g., via the imaging tool) may receive image data comprising at least one image, and control data associated with the imaging tool, and in response generate the tool configuration data.

The control data may indicate one or more of a description of the imaging task, a plurality of image tool settings associated with performing the imaging task (e.g., a confidence metric, average character height, text color, a contrast threshold, character width, character range, a string match, a region of interest (ROI)), and a schema of the tool configuration data used to configure the imaging tool. For example, the control data may include prompts for the model (e.g., a language model) that indicate the imaging task is an OCR task, the types of imaging tool settings associated with the imaging task for the model to configure, the type and/or range of values of the imaging tool settings, and the format of the tool configuration data for the imaging device 102. The model may perform one or more actions based upon receiving the prompts, such as analyzing the image data to identify text (e.g., text to undergo OCR), and configuring imaging tool with settings suitable for identifying the text according to the imaging task. The imaging tool may load the tool configuration data generated by the model, and process one or more test images to determine whether the settings are suitable for identifying text to OCR in the test images. In at least some embodiments, the imaging tool settings may include one or more default or preset values. The model may receive information (e.g., via the control file) indicating the preexisting values. In such embodiments, the model may generate values for settings without preexisting values, generate values which differ from preexisting values of settings, generate values for all settings, or any combination thereof.

In at least some embodiments, the imaging device 102 may perform the same imaging task as the computing device 104, such executing the same imaging tool of the computing device 104 on the imaging device 102 to perform the same OCR imaging task on a captured image. The imaging device 102 may load the tool configuration data to optimize the imaging tool for successfully perform the imaging task. The computing device 104 (e.g., via the imaging tool, the model) may generate the imager configuration data based upon the tool configuration data having optimized settings for performing the imaging task. The imager configuration data may include instructions associated with the imaging task for the imaging device 102 to perform, data to configure the operational parameters of the imaging device 102, settings or otherwise instructions for an imaging application (e.g., to perform the imaging task) of the imaging device 102 that correspond and/or are otherwise associated with the imager tool settings, and/or other suitable information. The computing device 104 may transmit the imager configuration data to one or more imaging devices 102. The imaging devices 102 may load the imager configuration data to similarly configure the imaging devices 102 with the optimized settings to perform the same imaging task as the imaging tool, however, the imaging devices 102 may be capable of performing the imaging task much more quickly as compared to the imaging tool.

### Example Processing Platform

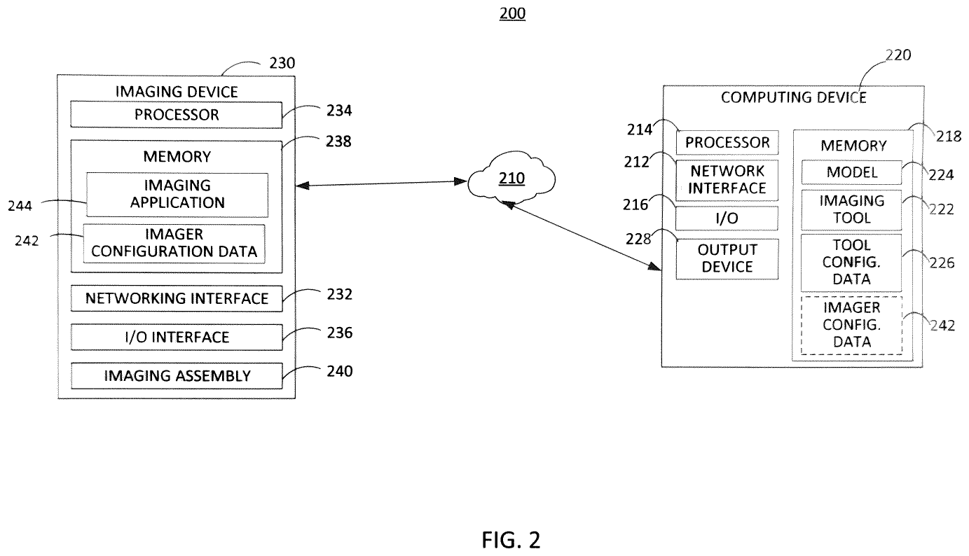

FIG. 2 is a block diagram depicting an example processing platform 200 for implementing example methods and/or operations described herein, according to embodiments. The example processing platform 200 includes a network 210 (e.g., the network 110), a computing device 220 (e.g., the computing device 104) and an imaging device 230 (e.g., the imaging device 102). Although the processing platform 200 is shown to include one network 210, one computing device 220, and one imaging device 230, it should be understood that the processing platform 200 may include additional, fewer, and/or alternate components, and may be configured to perform additional, fewer, or alternate actions, including components/actions described herein. Similarly, it should likewise be understood that the computing device 220 and/or imaging device 230 may include additional, fewer, and/or alternate components, and also may be configured to perform additional, fewer, and/or alternate actions, including the components and/or actions described herein. For example, the processing platform 200 may include a plurality of imaging device 230, all of which may be interconnected via the network 210. Similarly, the computing device 220 may include multiple processors 214, and may not include an output device 228. Furthermore, it should be appreciated that additional and/or alternative connections between components shown in FIG. 2 may be implemented. As just one example, the computing device 220 and the imaging device 230 may be connected via a direct communication link (not shown in FIG. 2) instead of, or in addition to, via the network 210.

The network 210 may include at least one communication and/or data network to communicatively couple components of the processing platform 200, such as enabling bidirectional communication between the computing device 220 (e.g., via the network interface 212) and the imaging device 230, and/or any other suitable device. The network 210 may comprise any suitable network or networks, including a local area network (LAN), wide area network (WAN), Internet, or combination thereof. For example, the network 210 may include a wireless cellular service (e.g., 4G, 5G, etc.). In one aspect, the network 210 may comprise a cellular base station, such as cell tower(s), communicating to the one or more components of the processing platform 200 via wired/wireless communications based on any one or more of various mobile phone standards, including NMT, GSM, CDMA, UMMTS, LTE, 5G, or the like. Additionally, or alternatively, the network 210 may comprise one or more wired and/or wireless data buses, modems, routers, switches, or other such connection points communicating to the components of the processing platform 200, which may include wired and/or wireless communications based on any one or more of various standards, including by non-limiting example, IEEE standards (e.g., 802.3, 802.11b/g/n/ac/ax, etc.), Bluetooth, and/or the like.

The computing device 220 may include the network interface 212, a processor 214, an input/output (I/O) interface 216, a memory 218, and an output device 228, any and/or all of which may be interconnected via an address/data bus or otherwise communicatively connected.

The network interface 212 may enable communication by the computing device 220 via the network 210. The example network interface 212 may include any suitable type of communication interface(s) (e.g., wired and/or wireless interfaces) and be configured to operate in accordance with any suitable protocol(s). For example, in some embodiments, network interface 212 may transmit data or information (e.g., image data, payloads, etc.) between remote processor(s), the imaging device 230, and/or other components.

The processor 214 may include one or more processors such as a microprocessor (μP), microcontroller, central processing units (CPU) and/or graphics processing unit (GPU) and/or any suitable type of processor. The processor 214 may include one or more logical processors (e.g., virtual execution unit(s) having one or more threads) and/or physical processors (e.g., hardware execution units having one or more cores) and may include multitasking and/or parallel processing. The processor 214 may control overall operations of the computing device 220. For example, the processor 214 may interact with the memory 218 to obtain, execute, and/or store data and/or instructions (e.g., machine-executable instructions) related to an imaging tool 222, a model 224, the output device 228, and/or other component(s) of the computing device 220. Additionally, or alternatively, machine-readable instructions corresponding to the example operations described herein may be stored on one or more removable media (e.g., a compact disc, a digital versatile disc, removable flash memory, etc.) that may be communicatively coupled to the computing device 220 to provide access to the machine-readable instructions stored thereon. In particular, the instructions stored in the memory 218, when executed by the processor 214, may cause the processor 214 to receive and analyze data image data.

The I/O interface 216 may enable receipt of input (e.g., via a user interface) and/or communication of output data (e.g., to an output device). For example, the user may provide input to the computing device 220 using an interface device (e.g., a mouse, keyboard, touchscreen, etc.) to via the I/O interface 216.

The memory 218 may be accessible by the processor 214 (e.g., via a memory controller), and/or other components of the computing device 220 and/or the processing platform 200. The memory 218 may include one or more suitable storage media such as a magnetic storage device, a solid-state drive, random access memory, volatile memory, non-volatile (e.g., non-transitory) memory, a database, and/or any other suitable memory. The memory 218 may be a local memory included within the housing of the computing device 220, memory communicatively coupled to the computing device 220 (e.g., a database coupled via an address/data bus and/or the network 210). The memory 218 may contain instructions which may be executed by the processor 214 or otherwise computing device, such instructions may include one or more software applications (e.g., the imaging tool 222), algorithms, modules, decoders, models, images for updating models, and/or other suitable instructions. The memory may store image data, models (e.g., the model 224), imager configuration data, tool configuration data, and/or other suitable data.

The memory 218 may store one or more tools (e.g., applications), such as the imaging tool 222. The image tool may perform one or more imaging tasks, such as OCR of text, a machine vision task, etc., via the computing device 220. The imaging tool 222 may include one or more settings, e.g., settings associated with performing an imaging task. For example, the imaging tool 222 may render a GUI on a display (e.g., the output device 228 via the I/O interface 216) and/or other communicatively coupled device. A user may interact with the GUI to view and/or edit various settings of the imaging tool 222, view images, input data, generate tool configuration data 226, imager configuration data 242 for the imaging device 230, etc. The imaging tool 222 may generate the tool configuration data 226 for configuring one or more settings of the imaging tool 222, such as a confidence metric, an average character height, a text color, a contrast threshold, a character width, a character range, an ROI, a string match, text optimization, and/or other suitable settings. In at least some embodiments, the imaging tool 222 may generate imager configuration data 242 to configure operational parameters of imaging device 230. The computing device 220 may provide the imager configuration data 242 to the imaging device 230 via the network 210. The tool configuration data 226 may be associated with a particular imaging task. In at least some embodiments, the imaging tool 222 may implement or otherwise execute the model 224, for example to generate the tool configuration data 226 and/or imager configuration data 242.

The memory 218 may store a model 224. The model 224 may be, and/or include, one or machine learning models (e.g., a neural network), algorithms, and the like. In some aspects, the machine learning methods and algorithms may include, but are not limited to linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented machine learning methods and algorithms are directed toward at least one of a plurality of categorizations of machine learning, such as supervised learning, unsupervised learning, and reinforcement learning. In some aspects, the machine learning model may be a generative model, a large language (e.g., large language model), and/or a multimodal machine learning model. In at least some implementations, the model 224 may be configured to receive image data (e.g., images captured by the imaging device 230 of an object including text and symbology on a barcode) and control data, and in response generate the tool configuration data for the imaging tool. The control data may include and/or indicate one or more of a description of the imaging task, imaging tool setting associated with performing the imaging task, or a schema for generating the tool configuration data for configuring the imaging tool settings. The tool configuration data may include and/or otherwise indicate one or more values for at least some of the plurality of settings based upon the control data and analysis of the image data. It should be understood that although the model 224 is described as having certain functionalities, such functionalities may be performed by additional models. For example, a single model may analyze the image data, a second model may generate the tool configuration data, and a third model may generate device configuration data. The model 224 may be configured to perform other functions (e.g., decoding a barcode in the image data).

The model 224 may be training, retrained, and/or fine-tuned, especially in the context of a machine learning model. In at least some embodiments, a base model may be configured to generate a plurality of configuration datasets corresponding to a plurality of tools, which includes generating the tool configuration data 226 for the imaging tool 222. The base mode may be fine-tuned to generate the model 224. The fine-tuning may cause the model 224 to have better performance (e.g., generate output data faster, use fewer computing resources, etc.) generating the tool configuration data for the imaging tool as compared to the performance of the base model generating the tool configuration data 226. One or more devices of the processing platform 200 may store, configure, update, and/or operate the model 224. For example, in some implementations, a server train, fine-tune, or otherwise configure the model 224. The computing device 220 may receive the configured model 224, store the model 224 in the memory 218), execute the model 224 (e.g., via the imaging tool 222, etc.). In other implementations, the computing device 220 may configure, store, and/or operate the model 224.

The output device 228 may be configured to receive (e.g., via the I/O interface 216) and/or output data, such as images of the image data, a GUI of the imaging tool 222, audio, video, texts, and/or other suitable data. The output device 228 may include one or more displays (e.g., LCD, LED, OLED), illumination devices/components (e.g., lights, LEDs), computing devices (e.g., mobile computing device, POS), and/or other suitable components to output data. It should be understood that although the output device 228 is depicted as a component of the computing device 220, the output device 228 may be otherwise communicatively coupled to the processing platform and/or the computing device 220.

The imaging device 230 may include a network interface 232 (e.g., the network interface 212), a processor 234 (e.g., the processor 214), an I/O interface 236 (e.g., the I/O interface 216), a memory 238 (e.g., the memory 218) and an imaging assembly 240, any and/or all of which may be interconnected via an address/data bus or otherwise communicatively connected.

The network interface 212 may enable communication by the imaging device 230 with the computing device 220 and/or components of the processing platform 200. The processor 234 may be configured to control the imaging assembly 240, execute applications, and/or control overall operation of the imaging device 230. For example, the processor 234 may interact with the memory 238 to obtain, execute, and/or store data and/or instructions (e.g., machine-executable instructions) related to the imaging assembly 240, such as causing the imaging assembly 240 to capture images. The I/O interface 236 may enable receipt of input data (e.g., device configuration data) and/or output data (e.g., image data), e.g., to the computing device 220 via the network 210.

The memory 238 may be accessible by the processor 234 (e.g., via a memory controller), the imaging assembly 240 (e.g., via a controller), and/or other components of the imaging device 230 and/or the processing platform 200. The memory 238 may store image data, imager configuration data 242 (e.g., received from the imaging tool 222 via the computing device 220), applications and/or other suitable data.

The imaging device 230 may load or otherwise implement (e.g., via the processor 234, the imaging application 244) the imager configuration data 242 to configure operational parameters of the imaging device 230. The operational parameters may include, or be associated with, exposure, focal distance, spatial resolution, the aperture, shutter speed, sensor gain, image processing, illumination, decoder, etc. In some embodiments, the imaging device 230 may have operational parameters that are unique to the imaging device (i.e., custom features). For example, one imaging device 230 may be configured with operational parameters for OCR, and another imaging device 230 may be configured with operational parameters for object recognition. The imager configuration data may be stored (e.g., in the memory 238) as, and/or include, one or more XML files, JSON files, Python code, and/or any other suitable data. The operational parameters may include a standard feature naming convention (SFNC) features, predetermined features preset features or custom features. In at least some embodiments, the imager configuration data 242 may include, and/or otherwise be based upon the tool configuration data 226. For example, imaging tool imaging tool 222 may generate the tool configuration data 226 associated with parameters and setting for performing an OCR imaging task that the imaging device 230 will perform. The imaging tool 222, model 224, or otherwise computing device 220 may generate the imager configuration data 242 that includes, or is otherwise based upon, the tool configuration data 226 the imaging device 230 uses to perform the OCR imaging task. The imager configuration data 242 may be the same data as the tool configuration data 226 (e.g., the same JSON file), the imager configuration data 242 may include the tool configuration data 226 along with other data, the imager configuration data 242 may include a portion of the tool configuration data 226, vice versa, and/or any combination thereof.

The memory 238 may store an imaging application 244 that, when executed, causes the imaging device 230 to perform one or more imaging tasks, such as capturing image data, performing OCR on an image to detect text, storing and/or transmitting (e.g., to the computing device 220) the image data, etc. In at least some embodiments, the imaging application 244 and the imaging tool 222 may be the same, or similar, applications, e.g., the same application to perform the same imaging task using the same application settings. In at least some embodiments, the imaging task may be indicated in the imager configuration data 242.

The imaging assembly 240 may include at least one image sensor and a controller. In particular, the at least one image sensor may be configured to capture image data comprising one or more images of the field of view (FOV) of the imaging device 230, e.g., a FOV including the object 108 on the conveyor belt 106. The image sensor may be and/or include a charge-coupled device (CCD) sensor, a complementary metal-oxide semiconductor (CMOS) sensor, a one-dimensional array of addressable image sensors, a two-dimensional array of addressable image sensors, a monochrome sensor, a color sensor, and/or any other suitable image sensor. Depending on the implementation, the image sensor may include a color sensor such as a vision camera in addition to and/or as an alternative to the monochrome sensor. The imaging assembly 240 may include one or more subcomponents, such as one or more controllers, and/or one or more imaging shutters (e.g., electronic and/or mechanical shutters configured to expose/shield the imaging sensor from the external environment). The one or more controllers may control and/or perform operations of the imaging assembly 240. The controller, the processor 234, and/or other suitable component may be configured to control the imaging assembly 240. The imaging assembly may include and/or be communicatively coupled to an illumination source (e.g., the illumination source) configured to emit illumination during a (predetermined) period corresponding to capturing image data via the imaging assembly 240, such as white light illumination, particular wavelengths (e.g., red wavelengths, IR) to suit the requirements of the imaging assemblies, etc. The imaging device 230 may have one or more operational parameters associated with illumination, a focal setting (e.g., focal distance to the object 108), an image sensor setting (e.g., contrast, resolution), image processing (e.g., image OCR, cropping, stitching), and/or other operational parameters. An adjustment or otherwise change may be made to one or more of the operation parameters of the imaging device 230 via the imager configuration data.

The imaging assembly 240 may be configured to capture image data which may comprise one or more images of a target object within the FOV, including, for example, packages, items, labels, and/or other target objects, which some examples includes merchandise available at retail/wholesale store, facility, or the like. The target objects may or may not include indicia, such as a barcode, a QR codes, a digital watermark, and/or other such indicia. The processor 234, the imaging application 244, the computing device 220, and/or other suitable component(s) of the processing platform 200 may analyze the captured image data of target objects and/or indicia passing through a FOV of the imaging assembly 240, e.g., for OCR of text, and/or any other suitable purpose.

### Example Imaging Device

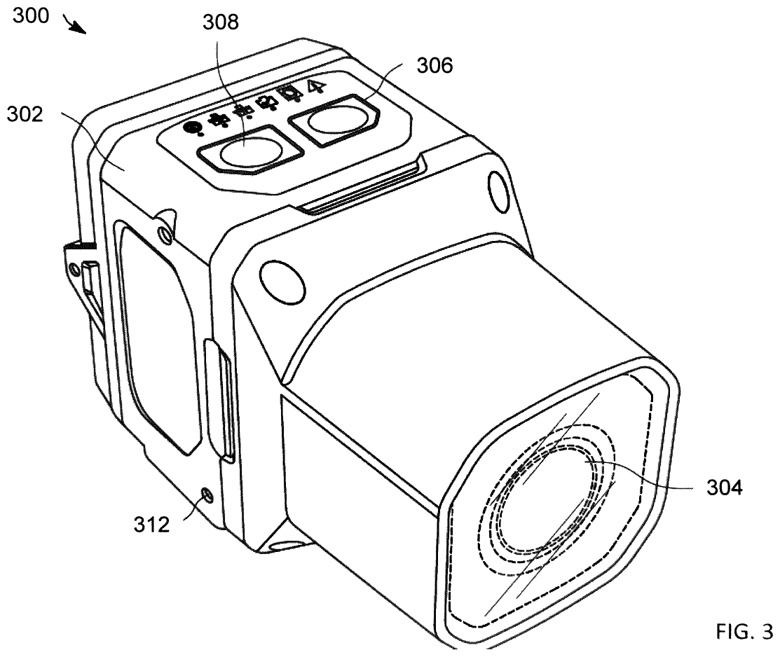

FIG. 3 is a perspective view of an example imaging device 300 (e.g., the imaging device 102, imaging device 230), according to embodiments. The imaging device 300, such as a machine vision camera, may be implemented as an imager for machine vision applications (e.g., an imaging task) in accordance with embodiments described herein. The imaging device 300 includes a housing 302, an imaging aperture 304, a user interface 306, a dome switch/button 308, and mounting point(s) 312.

### Example Machine Learning Model Training and Operation

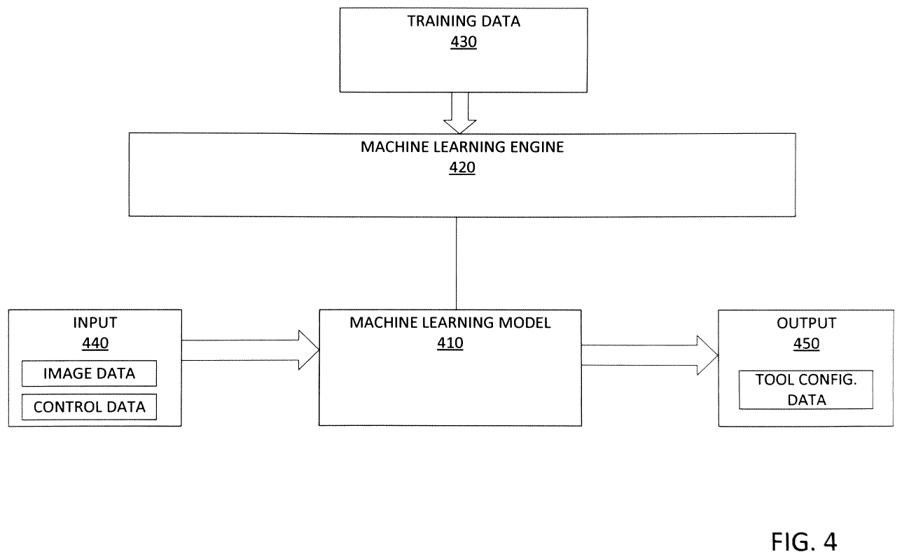

FIG. 4 is a flow diagram depicting example training and operation of a machine learning model 410 (e.g., the model 224), according to embodiments. Training, also referred to at times as configuring, and/or operation of the machine learning model 410 may be performed, for example, by the computing device 104, 220. The machine learning model 410 may be trained via a machine learning engine 420 using training data 430 to receive an input 440 and generate an output 450 in response.

A machine learning engine 420 may include one or more hardware and/or software components to obtain, create, (re) train, fine-tune, and/or store one or more machine learning models, such as the machine learning model 410. To train the machine learning model 410, the machine learning engine 420 may use training data 430. A computing device, such as a server, may obtain and/or have available one or more types of training data 430 (e.g., training data stored in the memory 218, an external database, etc.). In one aspect, at least some of the training data 430 may be labeled to aid in (re) training and/or fine-tuning the machine learning model 410. During training of the machine learning model 410 by the machine learning engine 420, the machine learning model 410 may be configured to process the training data 430 to learn associations and relationships in the training data 430. The training data may include, for example, historical image data, historical control data, and historical tool configuration data for performing associated historical imaging tasks. The machine learning model 410 may be trained to make association in the training data 430 such that when receiving the machine learning model 410 receives new image data and new control data which the model has not bee trained upon or otherwise processed for an associated imaging task, the model 410 is able to generate tool configuration data that is appropriate for the imaging task. In at least some embodiments where the machine learning model 410 may be trained to generate imager configuration data, the training data 430 may include historical imager configuration data of historical imagers for performing historical imaging tasks.

In some embodiments, the machine learning model 410 may be a generative model and/or include generative functionality allowing the machine learning model 410 to generate new content that is similar to, or inspired by, existing examples. For example, the machine learning model 410 may be trained to generate the imaging tool configuration data 226 based upon training data that includes historical tool configuration data.

The model 224 and/or machine learning model 410 may include language modeling (e.g., to process, generate, and/or receive prompts as the input 440) via one or more language models, such as a large language model (LLM), small language model, hybrid language model, and/or other suitable language model. In such an embodiments, the language model (e.g., deep learning models) are trained by processing token sequences using a language model architecture. For example, a transformer architecture may be used to process a sequence of tokens. The transformer model may include a plurality of layers including self-attention and feed-forward neural networks. The transformer architecture may enable the model to learn contextual relationships between the tokens, and to predict the next token in a sequence, based upon the preceding tokens. During training, the model is provided with the sequence of tokens and it learns to predict a probability distribution over the next token in the sequence. The training process may include updating one or more model parameters (e.g., weights or biases) using an objective function that minimizes the difference between the predicted distribution and a true next token in the training data. Alternatives to the transformer architecture may include recurrent neural networks, long short-term memory networks, gated recurrent networks, convolutional neural networks, recursive neural networks, and other modeling architectures.

In at least some aspects, the input 440 may include one or more prompts (e.g., prompts included in the control data), such as prompts using natural language. In some embodiments, the machine learning model 410 may perform one or more actions based upon receiving the prompts, such as generating the tool configuration data 226 as the output 450, etc. In some embodiments the machine learning model 410 may receive context or otherwise information for the imaging task (e.g., what the imaging task is meant to achieve), the imaging tool settings (e.g., what the settings are/do), the imaging tool setting values (e.g., the range of potential values), etc., based upon one or more prompts.

In at least some embodiments, responsive to the trained machine learning model 410 receiving image data and control data as the input 440, the trained machine learning model 410 generates tool configuration data (e.g., the tool configuration data 226) as the output 450. The imaging tool may load the tool configuration data to configure an imaging tool (e.g., the imaging tool 222) to perform an imaging task. The image data may include at least one image including text. The image(s) of the image data may be representative of the types of images the imaging device (e.g., the imaging device 102, 230) may capture when performing the corresponding imaging task. For example, the imaging task may be OCR of text and the imaging data may include an image including a label with text. In operation, the imaging device may perform the OCR imaging task on images of labels the imaging device captures. Thus, the image data may include images similar to images the imaging device may encounter when performing the imaging task.

The control data may indicate a description of the imaging task, imaging tool settings, and a schema of the tool configuration data. The imaging task may include OCR of text, locating an object, locating an edge of the object, identifying the number of edges, detecting a blob, locating the blob, counting blobs, locating a circle, and/or other imaging tasks performed on one or more images. Moreover, the imaging task may be performed on a region of interest within one or more images, such as OCR of text within a specific location of the image (e.g., upper righthand corner of an image of a label). The imaging tool settings associated with performing the imaging task may include one or more of a confidence metric, an average character height, a color of the text, a contrast threshold, a character width, a character range, a region of interest, a string match, or text optimization. The schema of the tool configuration data may indicate the format of information in the tool configuration data, such as object names, parameters, identifiers, syntax, file type (e.g., JSON, XML), etc.

In at least some embodiments, the control data may be associated with a particular imaging tool and/or a particular imaging task. For example, control data for an OCR imaging task may describe the OCR task, include imaging tool setting associated with the OCR, values of the OCR imaging tool settings, and the schema of the tool configuration data to configure the imaging tool for OCR.

The machine learning model 410 may analyze the one or more images of the image data to determine the image tool settings to configure, and what values to configure the image tool settings with, to successfully perform the imaging task on the image. For example, if the image of an OCR imaging task has text that appears faint, the machine learning model 410 may configure a contrast image tool setting with a value that makes that faint text appear more clearly for performing OCR.

In some embodiments, the machine learning engine 420 updates the training data 430 as needed, e.g., to include new data. Such data may be stored as updated training data 430. Subsequently, the machine learning model 410 may be retrained based upon the updated training data 430, or the new portions thereof, which may cause the performance of the machine learning model 410 (e.g., the quality of the output 450) to improve over time. For example, retraining the machine learning model 410 with new image data may cause the retrained machine learning model 410 to generate image tool configuration settings provide a higher success rate of performing an associated imaging task on images similar to those of the updated training data.

In at least some embodiments, training the machine learning model 410 may include fine-tuning of a base model to generate the model 410. For example, the base model may be trained or otherwise configured to generate a plurality of configuration datasets corresponding to a plurality of tools, such as an OCR imaging tool, an edge detection imaging tool, an edge count imaging tool, and a blob detection identification tool. The base model may be further trained, referred to as fine-tuning, to only generate the model 410 that generates tool configuration data for a particular imaging tool, such as the tool configuration data for the imaging tool. The fine-tuned model 410 may have better performance generating the tool configuration data for the imaging tool respective to performance of the base model generating the tool configuration data for the imaging tool. For example, the base model may be trained to generate configuration data for configuring hundreds of settings for dozens of imaging tools, whereas the fine-tuned machine learning model 410 may be configured to generate configuration data for configuring dozens of settings for a single imaging tool. The base model may require more computing resources to determine which imaging tool it is generating configuration data for based upon receiving input data as compared to fine-tuned model 410 which does not need to make such determination being that it is only configuring a single imaging tool.

In at least some aspects, the machine learning model 410 may be configured to generate imager configuration data 242 for the imaging application 244 for the imaging device 230. In such embodiments, the imager configuration data 242 may be based upon the tool configuration data 226, as previously described. For example, the same imaging task may be performed by the imaging tool 222 and the imaging device 230 (e.g., via the imaging application 244). Accordingly, upon receiving the imaging data and control data as the input 440, the model 410 may be able to generate both the imager configuration data 242 and the tool configuration data 226 as the output, as they include have similar information and/or settings for performing the same imaging task.

It should be understood that functionality described as being attributed to a single model may be performed by two or more models.

### Example Ocr Imaging Tool Configuration

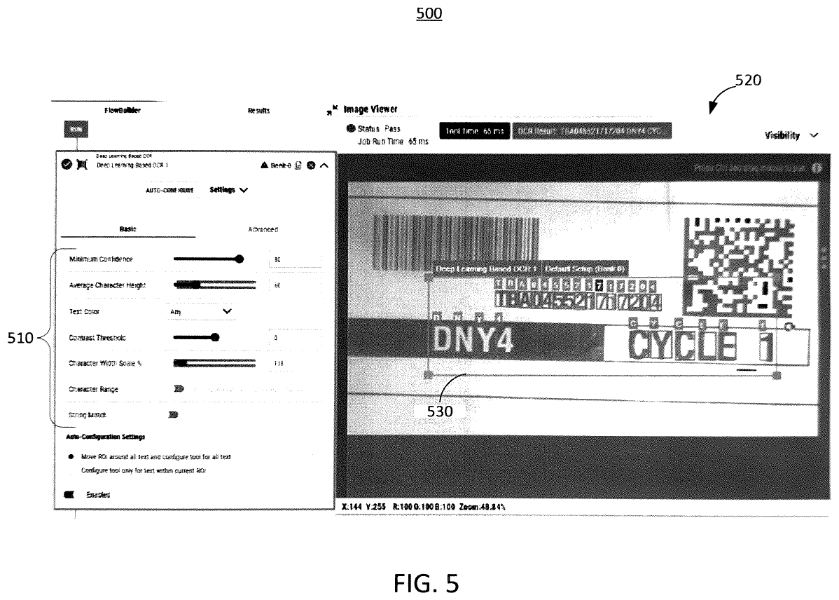

FIG. 5 depicts an example graphical user interface (GUI) 500 of an example OCR imaging tool (e.g., the imaging tool 222), according to embodiments. A computing device (e.g., the computing device 220) may generate the GUI 500 via the OCR imaging tool and output the GUI 500 to a display (e.g., the output device 228). The GUI 500 includes a plurality of settings 510 associated with configuring the OCR imaging tool to perform an OCR imaging task, the settings 510 including minimum confidence, average character height, text color, contrast threshold, character width, character range, and string match. The GUI 500 includes an image preview window 520 for previewing image data obtained by the computing device and/or the OCR imaging tool.

In operation, a user of the computing device may execute the OCR imaging tool to configure the tool to perform the OCR imaging task. The OCR imaging tool may include, have access to, or otherwise execute a model (e.g., the model 224) to perform functionalities associated with configuring the OCR imaging tool, among other things. The OCR imaging tool may receive control data associated with the OCR tool, as well as image data, from electronic storage, another computing device, etc., as previously described. The image data may include one or more images for configuring the imaging tool settings, such as images similar to images an imaging device may capture when performing the OCR imaging task.

The control data may describe or otherwise describe the imaging task. In at least some embodiments, the imaging task description may include natural language text and/or prompts. The model may include an LLM configured to understand the natural language and/or prompts of the control data. An example prompt may include the text, “You are an assistant that analyzes images to configure an OCR imaging tool application. Based on a provided image, configure the OCR imaging tool to find text in the image. Move a region of interest to tightly surround all the text found in the image.”

The control data may indicate the plurality of settings 510. For example, the control data may include the text, “Settings to perform OCR of the image are displayed using English language text labels in the graphical user interface of the OCR imaging tool. The labels shown in the graphical user interface are used to configure the OCR imaging tool to perform OCR on an image. Below are descriptions of the setting shown in the graphical user interface.” The control data may include information associated with the plurality of settings 510, such as the name of the setting, the purpose of the setting, the range of values for the setting, etc.

The control data may include a schema for the imaging tool configuration data the model generates. For example, the control data may include the text, “Below is a TypeScript contract for generating tool configuration data for each imaging tool setting. Do not use markdowns and do not wrap in backticks when generating the tool configuration data. Always generate the tool configuration data as JSON that conforms to the contract below.” The control data may further include JSON text in a schema that the model emulates when generating the tool configuration data.

In operation, the OCR tool may provide the image data and control data to the model. Responsive to receiving the image data and the control data, the model may perform the OCR imaging task on one or more images of the image data to generate the tool configuration data in the JSON schema proscribed by the control data. In at least some embodiments, current and/or preexisting values for the settings 510 may be included in the data sent to the model as an input. Such embodiment can allow the model to preserve one or more preexisting settings (e.g., preserving setting according to user preferences as indicated by the control data), only generate values for settings that differ from existing values (e.g., which may improve performance of the model), etc. The image data may contain multiple images, all of which the model analyzes when generating the tool configuration data, for example to understand the nature and degree of variations expected between images which may result in configuring improved imaging tool settings, and/or preventing the imaging tool setting from being too specific which may cause the imaging task to fail when performed.

In at least some embodiments, multiple imaging tools and/or imaging tasks may be configured at once based upon one or more subject images. In such embodiments, the model or imaging tool may determine which imaging tool is most applicable based upon subject image(s) and/or the control data, and configure the respective imaging tool.

The OCR imaging tool may load the tool configuration data. In response, the GUI 500 may display the plurality of settings 510, as well as image from the image data in the image preview window 520. The model may identify the ROI around the text in the image based upon a natural language prompt in the control data. Accordingly, loading the tool configuration data may cause the OCR imaging tool to generate the region of interest box 530 around the text in the image preview window 520. In some embodiments the model may be configured to determine the ROI of the image. In some embodiments, the model may analyze only the ROI in the image to generate imaging tool settings of the tool configuration data.

The prompts in the control data may cause the model to generate values for the settings 510 based upon analyzing the image and information provided in the control document. In some aspects one or more of the settings 510 may have no values, and in other aspects one or more of the settings 510 may have values populated when the model generates the tool configuration data. The values for the settings 510 the model generates via the tool configuration data may be entered into the GUI 500. The model may generate value that cause the imaging task to be successfully performed by the imaging tool on the image displayed in the image preview window 520. For example, the model may analyze the text in the interest box 530 to determine the width of the text characters, and generate a value for the character width based upon the text analysis.

In at least some embodiments, the model may eliminate at least one of the settings from the tool configuration data based upon the image data, the imaging task, and/or the control data. For example, an imaging tool setting may be associated with selecting a non-English text symbology of the text to be identified. The model may analyze the image to determine all the text in the image is English text, and eliminate the non-English text symbology setting from the tool configuration data. In another example, the control data may eliminate one or more setting when instructing the model. In yet another example, the control data may indicate the imaging task is an OCR task, and thus the model may eliminate a setting associated with detecting component defects for a machine vision imaging task.

In another aspect, the model may limit the range of values a settings based upon the image data, the imaging task, and/or the control data. For example, the values for character height may range from 5 to 100 pixels. Based upon analyzing the image or information in the control document, the model may limit the range of values to 20 to 70 pixels. In another example, the imaging task may be described as identifying a black barcode in an image, and as a result the model may limit the text color setting to black.

In at least some embodiments, the image data may comprise multiple images, such as test image data comprising a set of test images for testing settings of tool configuration datasets. In such embodiments, testing and/or otherwise evaluating imaging tool settings and/or tool configuration data may be performed in the background without the user being aware. For example, the model may generate first tool configuration data based upon analyzing one or more of the test images. The imaging tool may load the first tool configuration data, run the imaging task on the test image, and determine whether the imaging task achieves one or more metrics associated with the imaging task. The metrics may be associated with speed of performing the OCR task, text identification accuracy, region of interest identification accuracy, and/or any other suitable metric. Responsive to achieving the one or more metrics, the imaging tool may generate imager configuration data for configurating operational parameters of an imaging device.

Responsive to not achieving the one or more metrics, the model may generate one or more additional sets tool configuration data for the imaging tool to load, perform the imaging task, and determine whether the one or more metrics are achieved. The model may iteratively adjust one or more setting when generating each new tool configuration data for the imaging tool to test, until one of more of the imaging task performance metrics are achieved.

The imaging tool (e.g., via the model) may generate imager configuration data for configurating operational parameters of an imaging device. The imager configuration data may be based upon the tool configuration data, as previously described. The imaging tool or otherwise computing device may provide the imager configuration data to the imaging device to configure the imaging device to perform the OCR imaging task.

### Example Method for Configuring an Imaging Tool

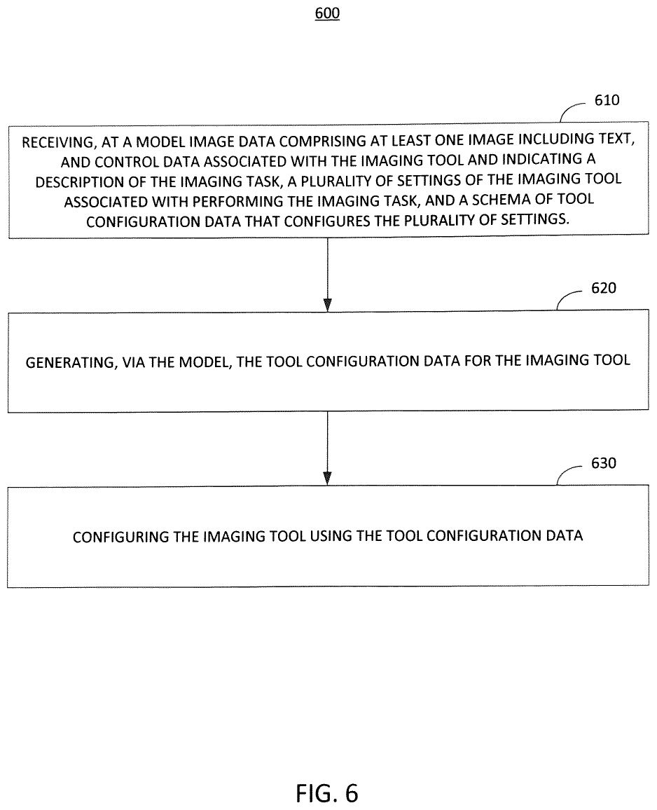

FIG. 6 depicts a flow diagram of an example method 600 for configuring an imaging tool (e.g., the imaging tool 222) to perform an imaging task, according to embodiments. One or more blocks of the method 600 may be implemented as a set of instructions stored on a computer-readable memory (e.g., the memory 218) and executable via one or more local or remote processors (e.g., the processor 214, 234). At least a portion of the method 600 may be implemented via the processing platform 200, the computing device 220, the imaging device 230, and/or other electronic or electrical components, which may be communicatively coupled with one another.

The method 600 may include at block 610 receiving, at a model (e.g., the model 224, 410) image data comprising at least one image including text, and control data associated with the imaging tool (e.g., the imaging tool imaging tool 222). The model may include one or more of a neural network, a generative model, or a language model. The control data may indicate one or more of a description of the imaging task, a plurality of settings of the imaging tool associated with performing the imaging task, and/or a schema of tool configuration data (e.g., the tool configuration data 226) that configures the plurality of settings. The control data may include one or more prompts configured for the model. The plurality of settings may include one or more of: a confidence metric, an average character height, a color of the text, a contrast threshold, a character width, a character range, a region of interest, a string match, or text optimization. The plurality of settings and/or the imaging task may be associated with performing optical character recognition on an image (e.g., the image data).

The method 600 may include at block 620 generating, via the model, the tool configuration data (e.g., a JSON file) for the imaging tool. The tool configuration data may indicate one or more values corresponding to at least a portion of the plurality of settings. Generating the tool configuration data (block 620) may include eliminating at least one setting of the plurality of settings being configured by the tool configuration data based upon the image data and/or limiting a range of values of the one or more values corresponding to at least the portion of the plurality of settings based upon the image data. The model may be configured to determine a region of interest and/or generate the tool configuration data may be based upon the a region of interest in the at least one image.

The method 600 may include at block 630 configuring the imaging tool using the tool configuration data.

In at least some embodiments, the method 600 may include receiving an indication of the imaging tool, of a plurality of imaging tools. In such embodiments, receiving at least the control data at the model may be responsive to receiving the indication of the imaging tool.

In at least some embodiments, the method 600 may include a base model configured to generate a plurality of configuration datasets corresponding to a plurality of tools, wherein: (i) the plurality of configuration datasets includes the tool configuration data, (ii) the plurality of tools include the imaging tool, (iii) fine-tuning of the base model generates the model, (iv) the fine-tuning configures the model to generate the tool configuration data for the imaging tool, and (v) the fine-tuning causes the model to have better performance generating the tool configuration data for the imaging tool respective to performance of the base model generating the tool configuration data for the imaging tool.

In at least some embodiments, the method 600 may include (i) performing the imaging task on a set of test images comprising test image data using the imaging tool configured with the tool configuration data; (ii) determining whether performance of the imaging task achieves one or more metrics associated with the imaging task; (iii) responsive to achieving the one or more metrics, (a) generating imager configuration data for configurating operational parameters of an imaging device, the imager configuration data based upon the tool configuration data, and (b) providing the imager configuration data to the imaging device; and (iv) responsive to not achieving the one or more metrics, modifying the tool configuration data via the model to improve the performance of the imaging task on the set of test images using the imaging tool. The operational parameters may be associated with one or more of an exposure, a focal distance, a spatial resolution, an aperture, a shutter speed, a sensor gain, an image processing, an illumination, or a decoder. The model may iteratively modify the tool configuration data until the one or more metrics are achieved by the imaging tool.

It should be understood that not all blocks of the exemplary flow diagram of FIG. 6 are required to be performed. Additionally, the method 600 may include fewer, additional, and/or other steps than those depicted in FIG. 6.

### Additional Considerations

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their respective entireties, for all purposes. Implementations of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112 (f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the implementations herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular implementations and applications have been illustrated and described, it is to be understood that the disclosed implementations are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

1. A method for configuring an imaging tool associated with performing an imaging task, the method comprising:
receiving, at a model:
image data comprising at least one image, wherein the at least one image includes text, and
control data associated with the imaging tool, wherein the control data indicates:
a description of the imaging task,
a plurality of settings of the imaging tool associated with performing the imaging task, and
a schema of tool configuration data that configures the plurality of settings;
generating, via the model, the tool configuration data for the imaging tool, wherein the tool configuration data indicates one or more values corresponding to at least a portion of the plurality of settings; and
configuring the imaging tool using the tool configuration data.

2. The method of claim 1, wherein generating the tool configuration data comprises:
eliminating at least one setting of the plurality of settings being configured by the tool configuration data based upon the image data; and/or
limiting a range of values of the one or more values corresponding to at least the portion of the plurality of settings based upon the image data.

3. The method of claim 1, further comprising:
receiving an indication of the imaging tool, of a plurality of imaging tools, wherein receiving at least the control data at the model is responsive to receiving the indication of the imaging tool.

4. The method of claim 1, wherein the tool configuration data includes a JSON file.

5. The method of claim 1, wherein the plurality of settings are associated with performing optical character recognition on an image.

6. The method of claim 1, wherein the plurality of settings include one or more of: a confidence metric, an average character height, a color of the text, a contrast threshold, a character width, a character range, a region of interest, a string match, or text optimization.

7. The method of claim 1, further comprising a base model configured to generate a plurality of configuration datasets corresponding to a plurality of tools, wherein:
the plurality of configuration datasets includes the tool configuration data,
the plurality of tools include the imaging tool,
fine-tuning of the base model generates the model,
the fine-tuning configures the model to generate the tool configuration data for the imaging tool, and
the fine-tuning causes the model to have better performance generating the tool configuration data for the imaging tool respective to performance of the base model generating the tool configuration data for the imaging tool.

8. The method of claim 1, wherein the model includes one or more of a neural network, a generative model, or a language model.

9. The method of claim 1, wherein the control data includes one or more prompts configured for the model.

10. The method of claim 1, wherein the model is configured to determine a region of interest (ROI) and/or generate the tool configuration data is based upon the ROI in the at least one image.

11. The method of claim 1, further comprising:
performing the imaging task on a set of test images comprising test image data using the imaging tool configured with the tool configuration data;
determining whether performance of the imaging task achieves one or more metrics associated with the imaging task;
responsive to achieving the one or more metrics,
generating imager configuration data for configurating operational parameters of an imaging device, the imager configuration data based upon the tool configuration data, and
providing the imager configuration data to the imaging device; and
responsive to not achieving the one or more metrics, modifying the tool configuration data via the model to improve the performance of the imaging task on the set of test images using the imaging tool.

12. The method of claim 11, wherein the operational parameters are associated with one or more of: an exposure, a focal distance, a spatial resolution, an aperture, a shutter speed, a sensor gain, an image processing, an illumination, or a decoder.

13. The method of claim 11, wherein the model iteratively modifies the tool configuration data until the one or more metrics are achieved by the imaging tool.

14. A system for configuring an imaging tool associated with performing an imaging task, the system comprising:
a model stored on one or more memories;
one or more processors; and
the one or more memories storing processor-executable instructions that, when executed by the one or more processors, cause the system to:
receive, at the model:
image data comprising at least one image, wherein the at least one image includes text, and
control data associated with the imaging tool, wherein the control data indicates:
a description of the imaging task,
a plurality of settings of the imaging tool associated with performing the imaging task, and
a schema of tool configuration data that configures the plurality of settings,
generate, via the model, the tool configuration data for the imaging tool, wherein the tool configuration data indicates one or more values corresponding to at least a portion of the plurality of settings, and
configure the imaging tool using the tool configuration data.

15. The system of claim 14, wherein to generate the tool configuration data further comprises instructions that, when executed, cause the system to:
eliminate at least one setting of the plurality of settings being configured by the tool configuration data based upon the image data; and/or
limit a range of values of the one or more values corresponding to at least the portion of the plurality of settings based upon the image data.

16. The system of claim 14, wherein the plurality of settings are associated with performing optical character recognition on an image, and/or include one or more of: a confidence metric, an average character height, a color of the text, a contrast threshold, a character width, a character range, a region of interest, a string match, or text optimization.

17. The system of claim 14, further comprising a base model configured to generate a plurality of configuration datasets corresponding to a plurality of tools, wherein:
the plurality of configuration datasets includes the tool configuration data,
the plurality of tools include the imaging tool,
fine-tuning of the base model generates the model,
the fine-tuning configures the model to generate the tool configuration data for the imaging tool, and
the fine-tuning causes the model to have better performance generating the tool configuration data for the imaging tool respective to performance of the base model generating the tool configuration data for the imaging tool.

18. The system of claim 14, further comprising instructions that, when executed, cause the system to:
perform the imaging task on a set of test images comprising test image data using the imaging tool configured with the tool configuration data;
determine whether performance of the imaging task achieves one or more metrics associated with the imaging task;
responsive to achieving the one or more metrics,
generate imager configuration data for configurating operational parameters of an imaging device, the imager configuration data based upon the tool configuration data, and
provide the imager configuration data to the imaging device; and
responsive to not achieving the one or more metrics, modify the tool configuration data via the model to improve the performance of the imaging task on the set of test images using the imaging tool.

19. The system of claim 18, wherein the operational parameters are associated with one or more of: an exposure, a focal distance, a spatial resolution, an aperture, a shutter speed, a sensor gain, an image processing, an illumination, or a decoder.

20. A non-transitory computer-readable medium storing instructions that, when executed by one or more processors, cause the one or more processors to:
receive, at a model:
image data comprising at least one image, wherein the at least one image includes text, and
control data associated with an imaging tool, wherein the control data indicates:
a description of an imaging task,
a plurality of settings of the imaging tool associated with performing the imaging task, and
a schema of tool configuration data that configures the plurality of settings;
generate, via the model, the tool configuration data for the imaging tool, wherein the tool configuration data indicates one or more values corresponding to at least a portion of the plurality of settings; and
configure the imaging tool using the tool configuration data.
